(19) United States
(12) Patent Application Publication
(10) Pub. No.: US 2004/0239551 A1
(43) Pub. Date: Dec. 2, 2004

(54) Fire arm safety tracking system and data base

(76) Inventor: Joyce M. Ellis, Memphis, TN (US)

Correspondence Address: Mrs. Joyce Ellis, 1616 Michelle Circle, Memphis, TN, 38107, US

(21) Appl. No.: 10/449,779

(22) Filed: Jun. 2, 2003

(51) Int. Cl. G01S 13/66

(52) U.S. Cl. 342/42; 342/44; 342/52; 342/58; 342/61; 342/357.07; 342/357.08; 342/357.09; 342/357.1

(57) ABSTRACT

As previously mentioned in the introduction this concept uses components already available and in use, but not being used to achieve this systems goals of providing a safeguard for weapon user/owner their families, and societies. Communications technology combined with firearms to enhance the weapons reliability and improve on its significance as a vital instrument of protection. This modification will bring age-old safety into the information age.

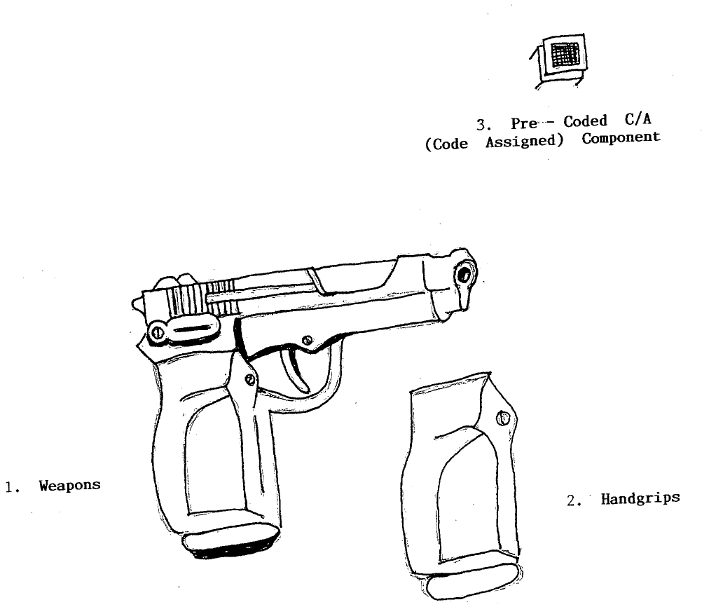

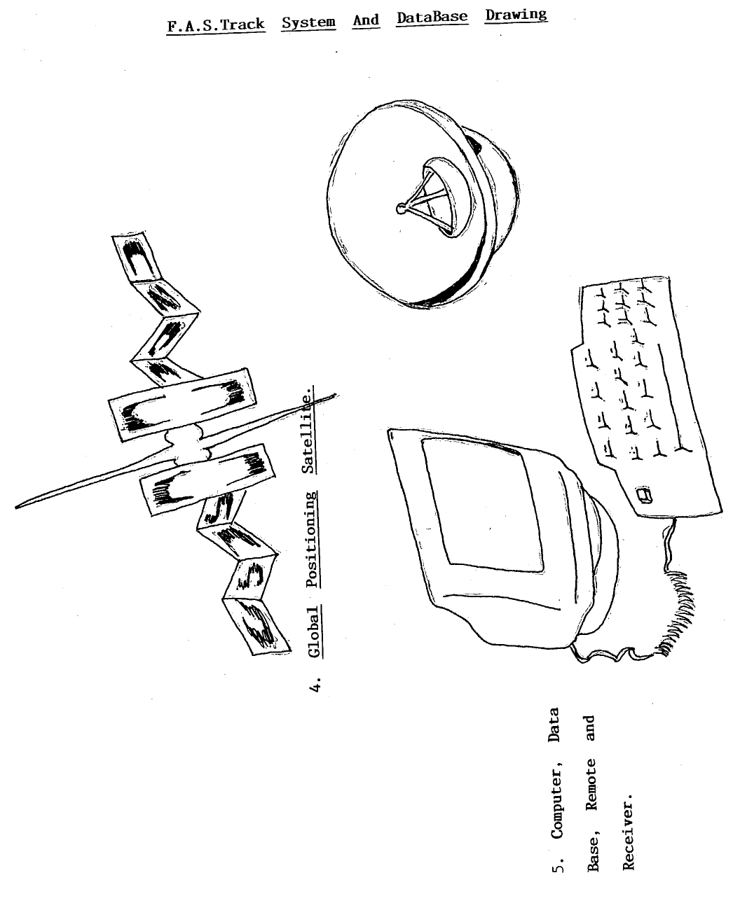

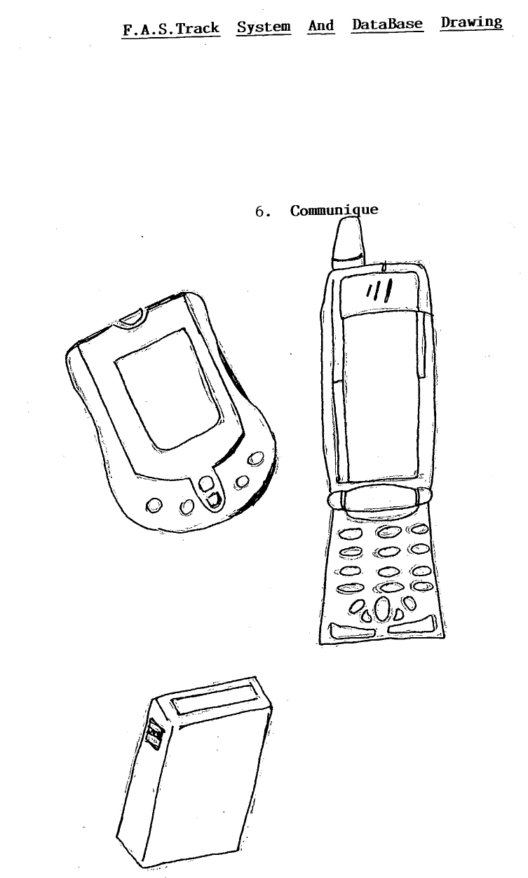

Introduction: This concept was previously identified as Disclosure Document No. 492371 on Apr. 17, 2001 by the U.S.P.T.O.

This concept is unique because it allows for a more sophisticated avenue of professional protection for individual firearm ownership. This extends far beyond the traditional scope intended by its original designs. This concept recognizes the dangers of the current era and those the future as well. This system enhances the safeguards of the weapon with slight modification of the weapon's grip or butt area. This conversion will not impose on the weapons intended function nor impose on the user/owner's Second Amendment Right To Bear Arms as afforded by the Constitution Of The United States Of America.

Under this concept weapons are tracked by attaching a Pre-Coded C/A (Code Assigned) Chip (Component) which emits a series of distinct signals to a (G.P.S.) (Cont'd) Global Positioning Satellite. The G.P.S. receivers transmit remotely to other receivers attached to the data base and together distinguish proximate location of the signals origin then simultaneously records the information while the network continually monitors.

As previously mentioned, and shown in the drawings on the following pages the F.A.S.Track System And DataBase consists of the following:

1. Weapons safety is the focal requisite in accomplishing the systems targeted goal. Achieving this will begin with slight modification of the weapons structure, but will not impede or interfere with the weapons objective or performance in any manner. This system will assert a set of checks and balances that will act in unison as a network insuring the reduction of personal negligence, and limiting the opportunity for personal liability to occur.

2. Handgrips, Pistolgrips, or Rifle Butts, for the storage and the ultimate modification of the weapon for the communication component the pre-coded C/A Chip.

3. The emission of the original communication signal will orginate from the Pre-Coded C/A (Code Assigned) Chip embedded in the grips or butt of the weapons base.

4. Signal Transmission and Receiving will occur by remote via Global Positioning Satellite. Another remote will adjoin the data base and computer's receiver.

5. Computer—data base (Hard Drive) with G.P.S. remote link will have MegaByte and or GigaByte (character) storage capabilities that record all relevant information such as geographical location of the tracked device in real time and continuous mapping where permitted. All data will remain classified until a time deemed appropriate by the user/owner or an authorized investigative agency.

6. Communique including cellular technology—phones and pagers, digital technology—phones, pagers, computers, laptops, P.D.C. (Personal Digital Computers) and E-mails are available vehicles that will provide the user/owner with the proximate location of their weapon. This will therefore act as a deterrent to weapon theft as well make available this information authorized agencies for investigative purposes covered under and in practice with the law.

6. Communique (cont'd) The F.A.S.T.rack system will employ the necessary safeguards to prevent interception of all such intimate materials by computer rogues or those operating outside of established legal parameters set by the government.
* Note: The clarity of the signals reception will vary in accordance with geogeaphical location of the original signal and the mode with which the user/owner options to monitor communication.
